(19) United States
(12) Patent Application Publication
(10) Pub. No.: US 2024/0025773 A1
(43) Pub. Date: Jan. 25, 2024

(54) MODULAR PUMP FOR RESIDENTIAL REVERSE OSMOSIS SYSTEM

(71) Applicant: CULLIGAN INTERNATIONAL COMPANY, Rosemont, IL (US)

(72) Inventors: Tedd M. SCHNEIDEWEND, Glen Ellyn, IL (US); Doug ANDERSON, St. Charles, IL (US); Adam SLOMA, Arlington Heights, IL (US); Sajid Ali SYED, Grayslake, IL (US); Jacob John SERENA, Schaumburg, IL (US)

(21) Appl. No.: 18/355,128

(22) Filed: Jul. 19, 2023

Related U.S. Application Data
(60) Provisional application No. 63/369,043, filed on Jul. 21, 2022.

(51) Int. Cl. C02F 1/44

(52) U.S. Cl. CPC C02F 1/441; C02F 2201/005; C02F 2209/03; C02F 2209/40

(57) ABSTRACT

A modular pump is provided for a water treatment system, and includes a housing having a water inlet and a separate water outlet, a pump located in the housing and being in fluid communication with the water inlet, a check valve located within the housing downstream of and in fluid communication with the pump, a flow meter located within the housing and in fluid communication with, the check valve, a pressure sensor located within the housing, in communication with, and downstream of the check valve, and in fluid communication with the water outlet. Also, a control system is electrically connected to the pump, the pressure sensor and the flow meter.

### RELATED APPLICATION

This application is a Non-Provisional of, and clams 35 USC 119 priority from U.S. Ser. No 63/369,043 filed Jul. 21, 2022, the entire contents of which are incorporated by reference.

### BACKGROUND

The present invention relates generally to drinking water treatment devices, and more specifically to residential Reverse Osmosis (RO) water treatment systems. In conventional water treatment systems, incoming potable water is further treated to remove suspended particles, referred to as Total Dissolved Solids (TDS), unwanted chemicals, unpleasant taste, excessive minerals and the like. Such treatment systems typically include at least one activated carbon filter connected in series to an RO unit.

RO water treatment systems are known in the art, and exemplary systems are described in U.S. Pat. Nos. 7,338,595 and 9,616,388 which are incorporated by reference. Conventional residential RO water treatment systems include a treatment container, vessel or cartridge having an RO membrane which is porous, but the pores are small enough to capture a wide range of impurities. In many systems, the RO treatment container is provided in series with prefilters of granulated carbon, carbon block, glass fibers or the like which are designed to remove, among other things, larger unwanted particles, odor and other impurities before the feed water reaches the RO membrane. The RO unit includes a fine pore membrane for performing high level filtration. Incoming water is fed at high pressure through the membrane, and solid retentate captured by the membrane is removed and sent to drain before the treated water is stored in a storage tank. Employing an RO unit in a water treatment system reduces the TDS concentration level to between 0-50 ppm (0-50 mg/L).

Downstream of the RO membrane is a treated water storage tank which is ultimately connected to a faucet mounted near the sink. In many cases, the faucet is dedicated to dispensing only the treated water from the storage tank. The designated faucet is connected directly to an outlet of the water treatment system, typically mounted in a cabinet under the sink. In other cases, the RO water storage tank is connected to a main faucet that has a selector for switching between ordinary tap water and treated water from the storage tank.

For households with low water pressure, or which receive feed water from a well, and other systems having water pressure less than 40 psi, many RO water treatment systems include a pump for injecting the water into the filter array that includes the RO treatment container. The pump is used to push water against and through the RO membrane. Such systems typically include a pressure switch in line with the storage tank which is configured for turning off the pump once the treated water storage tank is full. In these systems, the pump takes line pressure and pumps at 120 psi to push the water through the RO membrane and to fill the storage tank. As the user draws down water for drinking, coffee, etc., at some point the pressure in the storage tank will drop, causing the pump to be turned on again. Thus, the pressure switch is used to control the pump.

A drawback of such systems including a pump and the related electronic controls is that a significant amount of labor is involved in setting up the system at the residence, including relatively complicated wiring. In addition, the amount of components required is extensive, which raises installation and maintenance costs.

Accordingly, there is a need for an improved residential RO system which is relatively easy to install and includes fewer components than conventional systems.

### SUMMARY

The above-listed need is met or exceeded by the present modular pump designed for residential RO systems, which is configured for allowing the customer/user to use a relatively simpler and less expensive pump, but which also has a check valve, a flow meter and a pressure transducer instead of the conventional pressure switch and more expensive pump. The present assembly, along with a controller/PCB board, is provided in a compact modular housing that is relatively easily plugged in to the existing inlet line with quick-connect fittings. As such, the present pump is more easily connected and more efficiently operated than in conventional systems.

Included in the present RO pump modular housing is that the conventional pressure switch is replaced by a pressure sensor and a flow meter, which when connected to the control system logic, reduces the amount of wiring found in conventional systems and is configured for immediate operation without any required set up. The control system logic is configured for generating an alarm signal (visual and/or audible) upon malfunctions of the pressure transducer, the flow meter or the pump itself, as well as a shut off of the water feed inlet, a leak in the system, such as between the pump and the RO unit.

The main components within the modular housing include the pump, a check valve preventing water flow back to the pump and which is also used to hold the designated pressure, such as at 120 psi, until water is needed due to use by the user of water in the RO storage tank. A flow meter is connected downstream of the check valve, and is configured to control the operation of the pump, and the tank filling process, as the RO storage tank is close to being filled. A pressure transducer connected downstream of the flow meter is configured to trigger pump operation as system pressure falls below preset levels, and modular pump further includes a printed circuit board (PCB) upon which is mounted a control system. As is known in the art, the control system includes a programmable processor provided with the operational logic and preset operational parameters of the system. Both the pressure sensor/transducer and the flow meter are connected to the control system. Water inlet and outlet connections to the modular housing are achieved using conventional quick-connect connectors.

In a preferred embodiment, the check valve holds the line pressure downstream of the pump at 120 psi after the pump shuts off By maintaining the line pressure at 120 psi or the preset value, the RO membrane continues operation in that there is a head of pressure against the membrane. As the user draws water from the storage tank, eventually the water in the line upstream of the RO membrane and downstream of the check valve will be drawn down, the resulting decrease in pressure causing the pressure sensor to signal the pump to turn on. The flow meter and the pressure sensor are configured to signal the PCB when to turn the pump off

More specifically, a modular pump is provided for a water treatment system, and includes a housing having a water inlet and a separate water outlet, a pump located in the housing and being in fluid communication with the water inlet, a check valve located within the housing downstream of and in fluid communication with the pump, a flow meter located within the housing and in fluid communication with the check valve, a pressure sensor located within the housing, in communication with, and downstream of the check valve, and in fluid communication with the water outlet. Also, a control system is electrically connected to the pump, the flow meter and the pressure sensor.

In an embodiment, the water inlet and the water outlet are both equipped with quick connect fittings. Preferably, the quick connect fittings are horizontally aligned with each other.

In an embodiment, the housing includes two mounting brackets, and is configured for fully enclosing the pump, the check valve, the flow meter, the pressure sensor and the control system. Also, the housing is provided on an external surface with flow direction indicators for facilitating connection to an existing water treatment system.

In one embodiment, the modular pump includes an external leak detector connected to the control system.

In an embodiment, the control system is configured for generating an alarm signal in response to at least one of a water leak, a water inlet shutoff, pump malfunction, flow meter malfunction and pressure transducer malfunction. A water treatment system including the present modular pump is also provided.

In an embodiment, the pump in the modular pump is constructed and arranged to activate based on at least one of a pressure signal and a flow signal based on water demand.

In another embodiment, A modular pump for a water treatment system including an RO membrane and an RO treated water storage tank, the modular pump including a housing having a water inlet and a separate water outlet in fluid communication with the RO treated water storage tank, a pump located in the housing and being in fluid communication with the water inlet, a flow meter located within the housing and in fluid communication with the pump, a pressure sensor located within the housing, in communication with the flow meter, and with the water outlet, and a control system electrically connected to the pump, the flow meter and the pressure sensor and configured for operating the pump in response to signals generated by at least one of the flow meter and the pressure sensor, the signals reflecting water demand due to usage of treated water from the water storage tank.

### BRIEF DESCRIPTION OF THE DRAWINGS

FIG. 1 is a schematic of a prior art water treatment system including an RO unit and a conventional pump connection;

FIG. 2 is a top perspective of a first embodiment of the present RO pump module;

FIG. 3 is a top perspective view of a second embodiment of the present RO pump module;

FIG. 4 is a top view of the internal components of the present RO pump module;

FIG. 5 is an exploded perspective view of the present RO pump module; and

FIGS. 6A and 6B are an operational schematic of the control system for the present RO pump module.

### DETAILED DESCRIPTION

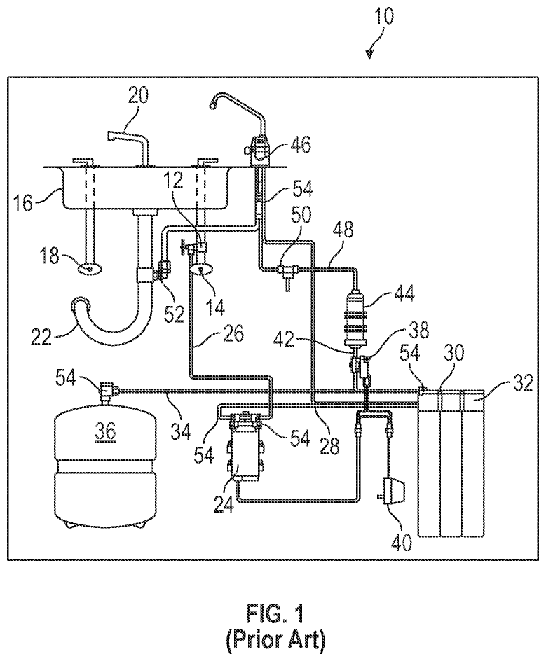

Referring now to FIG. 1, a prior art water treatment system is generally designated 10, and is connected to a water supply 12, usually associated with a cold water supply connection or shut off valve 14 under a sink 16, usually a kitchen sink which also has a separate hot water supply connection 18 a faucet 20 and a drain pipe 22. Included in the water treatment system 10 is a pump 24 preferably powered via a connection to line voltage supplied through a wall plug 40. A conduit or pipe 26 connects the pump 24 with the cold water supply connection 14. After the pump 24, the water flows through a conduit or pipe 28 to a multi-filter unit 30 including multiple cartridges connected in series for removing additional contaminants such as mercury, cysts, volatile organic contaminants, chlorine, taste, odor and some minerals. An RO membrane unit 32 is one of the cartridges in the multi-filter unit 30.

Downstream of the RO membrane unit 32, a conduit or pipe 34 connects an outlet of the RO unit to a treated water storage tank 36. A pressure switch 38 is connected to the pump 24 for activating the pump when line pressure falls below a reset level.. As described above, the pump 24 is an optional feature, employed primarily in residences where the water pressure is relatively low, in the range of 40 psi. As a point of comparison, residences supplied by city water receive water at pressures in the range of 50-60 psi. Many residences supplied by well water need the pump 24, which increases the flow of water through the RO membrane unit 32.

Downstream of the treated water storage tank 36, the water flows through a conduit 42 to a postfilter 44, usually using granulated activated carbon for removing additional contaminants A designated faucet 46 is connected to the postfilter 44 using a conduit or pipe 48. In some applications, a shutoff valve 50 is supplied to facilitate servicing of the water treatment system 10. Venting of the designated faucet is provided by a drain conduit 52 connected to the drain pipe 22. As is well known in the art, quick-connect, push-on type connectors 54 are employed for connecting the conduits or pipes 26, 28, 34, 42 and 48 to the relevant components. Suitable connectors 54 are manufactured by Colder Products Company (www.cpcworldwide.com), among other vendors. Also, it is contemplated that the pipes or conduits 26, 28, 34, 42 and 48 are either rigid pipe or flexible tubing, and both are well known in the art.

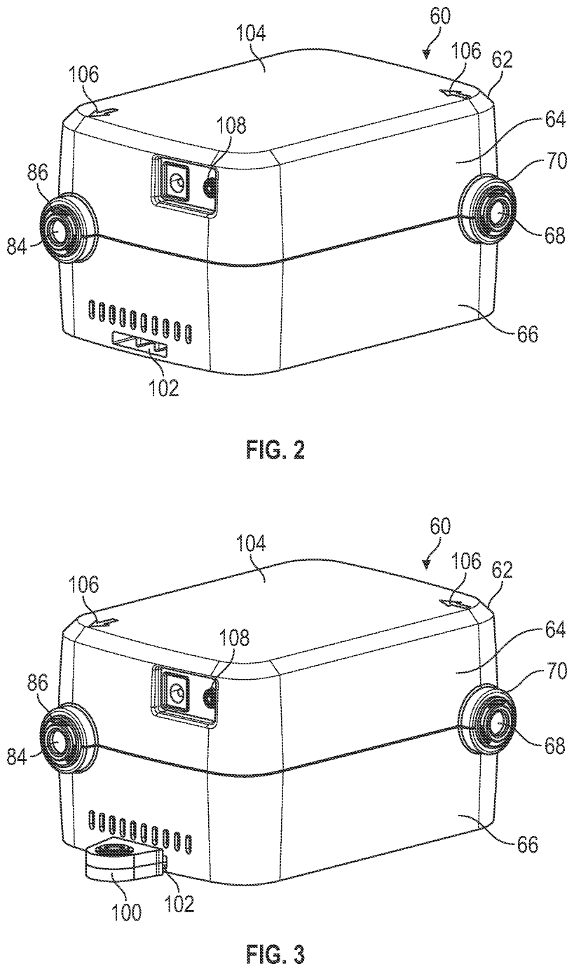

Referring now to FIGS. 2-5, as described above, in residences with low water pressure often require the pump 24 to increase water pressure sufficiently to efficiently operate the RO membrane unit 32, among the other components of the water treatment system 10. Installation of the pump 24 is tedious and involves complicated wiring and connections to the pressure switch 38 associated with the treated water storage tank 36.

Accordingly, the present modular pump, generally designated 60 is configured for providing enhanced pressure to systems needing such a boost for operating the water treatment system 10. Among other features, the modular pump 60 is constructed and arranged for installation in the water treatment system 10 of FIG. 1, replacing the pump 24 and its associated wiring and the pressure switch 38. The remaining components shown in FIG. 1 are retained. The present modular pump 60 is a self-contained system for monitoring and maintaining water pressure as needed by the water treatment system 10 without requiring complicated wiring, extensive setup or connection to external components.

Included in the present modular pump 60 is a housing 62, preferably provided in upper and lower clamshell halves 64, 66. An inlet 68 is equipped with a quick connect fitting 70 similar to the fittings 54 and connects the pump to the conduit 28 providing water to the multi-filter unit 30. A pump 72 has a pump inlet 74 in fluid communication with the inlet 68, and is powered through line voltage using a wall plug (not shown) similar to the wall plug 40. While other models are contemplated, a suitable pump 72 is configured to have a minimum inlet pressure of 30 psi, a maximum outlet pressure of 130 psi, and a flow rate 0.550 ml/min) Other models and performance ranges of pumps are contemplated depending on the application.

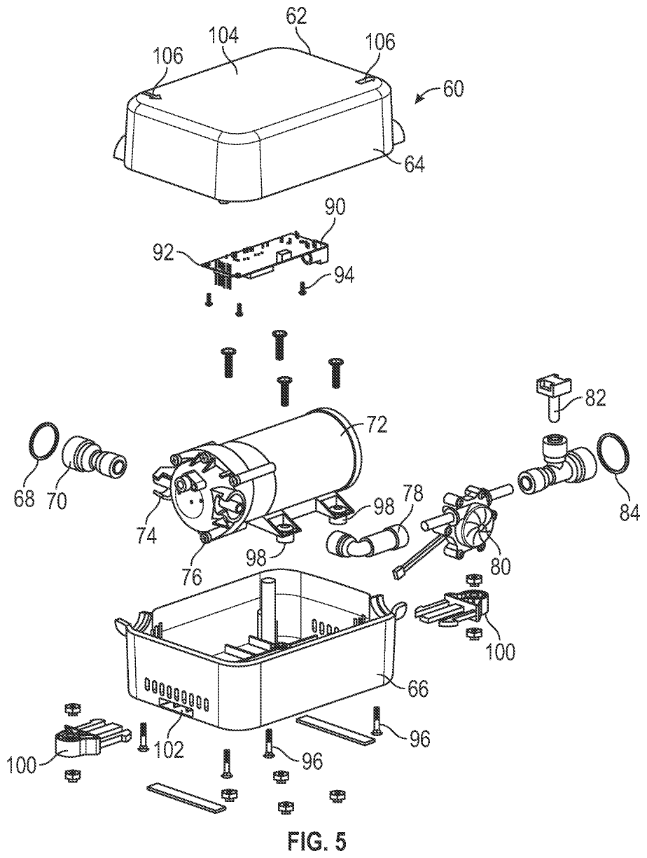

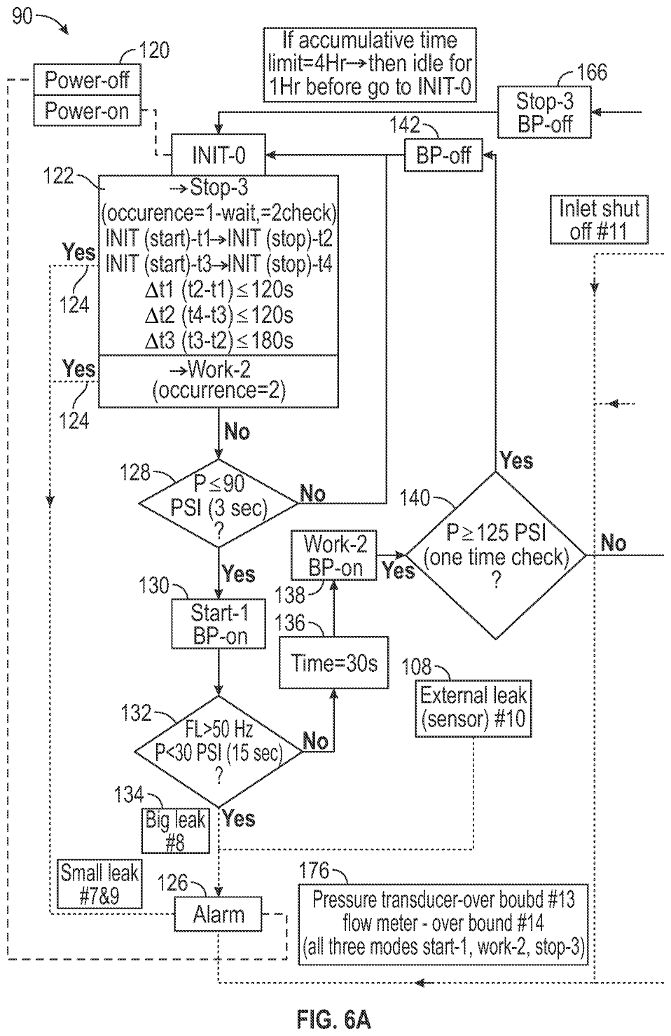

Referring now to FIGS. 4 and 5, a pump outlet 76 is connected to, and is in fluid communication with a check valve 78 that is within the housing 62 downstream of the pump 72 and is configured for holding the downstream pressure at 120 psi as it prevents backflow into the pump 72. Next, the check valve 78 is connected to a flow meter 80 located within the housing 62 and in fluid communication with the check valve. As will be described below in greater detail, the flow meter 80 monitors operation of the pump 72 and the pump output as the treated water storage tank 36 reaches full capacity. While other models are contemplated as are known in the art, a suitable flow meter 80 is configured for using the Hall Effect, when water passes through a rotor assembly, the rotor assembly with magnet rotates and the rotation speed changes with the change of flow rate. The Hall Effect sensor outputs the corresponding pulse signal to feed back. In the preferred embodiment, the flow range is 0.15-2.0 L/min, however other ranges are contemplated depending on the application.

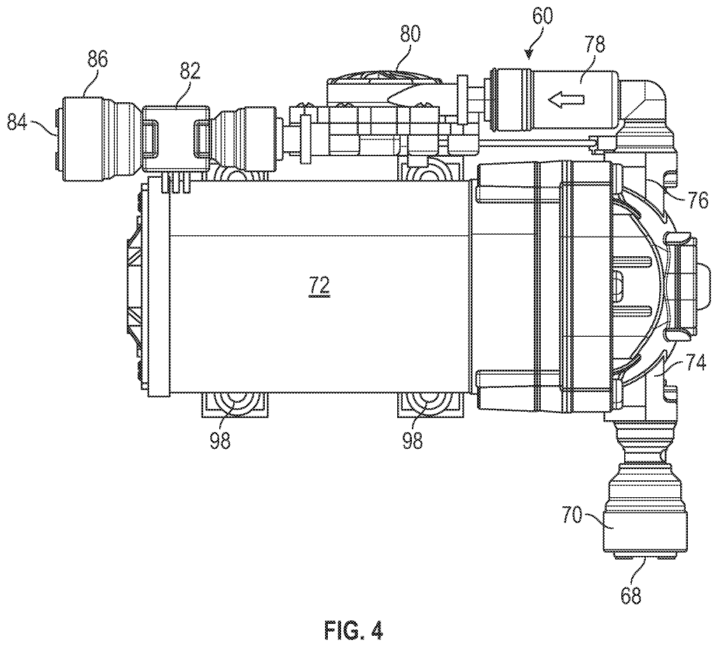

A pressure sensor 82 is located within the housing 62, is in communication with, and downstream of the check valve 78, and is in fluid communication with a modular pump water outlet 84. The pressure sensor 82 is preferably a circuit module composed of a silicon differential pressure sensor chip and ASIC, which is encapsulated on 11*11 mm Al₂O₃ ceramic substrate, with a preferred pressure range of 0-145 psi. Other suitable sensors are contemplated depending on the application. As is the case with the inlet 68, the water outlet 84 is provided with a quick connect fitting 86. Referring to FIGS. 2 and 3, preferably the water inlet 68 and the water outlet 84 are horizontally aligned with each other.

Referring now to FIG. 5, a control system 90 is preferably located within the housing 62 and is electrically connected to the pump 72, the flow meter 80 and the pressure sensor 82. Preferably, the control system 90 is mounted on a printed circuit board (PCB) 92 secured to the housing 62, preferably the housing half 64 using fasteners 94. Similarly, the pump 72 is secured to the housing 62, preferably the opposite housing half 66, using fasteners 96 engaging mounting openings 98. Also, the housing 62 is preferably provided with two mounting brackets 100 slidably, frictionally engaged in slots 102. The brackets 100 facilitate securing the housing 62 in the treatment system 10, such as to an inside wall of an under sink cabinet, via the use of fasteners such as screws or the like. In a preferred embodiment, the housing 62 is provided on an exterior surface 104 with water flow direction indicators 106 that simplify installation to the water treatment system 10. It will be seen that the housing 62 fully surrounds the pump 72, the check valve 78, the flow meter the pressure sensor 82 and the control system 90. Optionally, the housing 62 is provided with an external leak detector or sensor 108. The leak sensor 108 detects a water leak when water touches a pair of metal rods. Thus, the sensor 108 behaves as an open circuit when no water is present and behaves as a resistor when water is present.

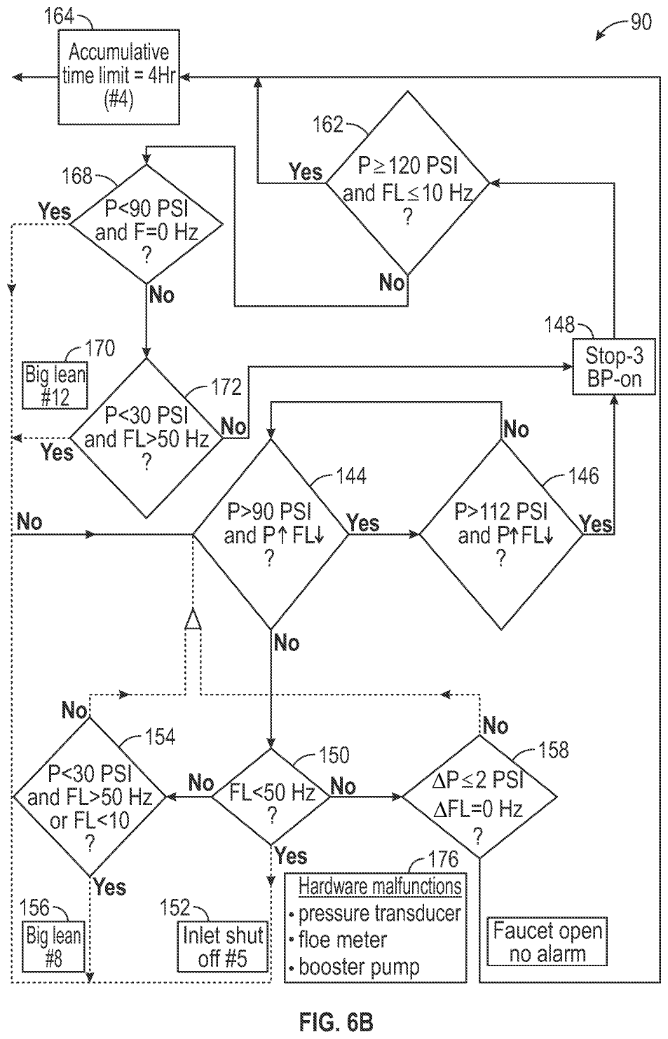

Referring now to FIGS. 6A and 6B, a flow chart represents the control system 90. It will be understood that the various values and parameters listed may change depending on the application. As is known in the art, the control system 90 includes a programmable processor mounted to the PCB 92 provided with the operational logic and preset operational parameters of the system, as described below. In general, the control system 90, working through the PCB 92, controls operation of the pump 72 so that the pump is activated based on at least one of a pressure signal and a flow signal based on water demand triggered by the user removing treated water from the water storage tank 36.

At step 120, an ON/OFF power connection is either plugged or unplugged is activated to fully install the present pump module 60. Once the power is ON, the module 60 remains activated until it is unplugged for repair or replacement. Once ON, the PCB 92 in the control system 90 performs an initial status check at step 122, including monitoring the incoming pressure measured by the pressure sensor 82 and relevant data is collected. At this point the pump 72, designated BP (for “booster pump”) in the flow chart of FIGS. 6A and 6B, is inoperative.

The PCB 92 in the control system 90 checks whether system pressure is less than or equal to 90 psi over a period of 3 seconds, then the pump 72 will start at step 130. If the pressure is sufficiently high, the pump 72 remains off and the system 90 loops back to the status check 122. Next, at step 132, the PCB 92 in the control system 90 monitors pressure and flow for at least 15 seconds. If the pressure remains low, preferably below 30 psi and flow high, above 50 Hz, at step 134 a large leak is detected, and the alarm is triggered at 126. If the pressure is above a certain level and the flow is below certain level, the pump 72 is kept on for 30 seconds at step 136 without monitoring pressure and flow, and the pump 72 is kept on at step 138. Next, at step 140, the pump 72 is kept on unless the pressure reaches at least 122 and preferably 125 psi, at which time the pump is turned off at step 142.

Referring now to step 144, if the pressure does not reach 125 psi, but is greater than 90 psi and pressure is increasing while flow is decreasing (called a “pressure trend-up,” “flow trend down”), the PCB 92 of the control system 90 checks again at step 146 to see whether the pressure is over 108 psi with increasing pressure and decreasing flow. If so, at step 148, the pump 72 is kept on.

Referring now to step 162, if the pressure reach 116 psi and flow is decreasing below 5 Hz (frequency), cycle is completed at step 166 BP is off. Referring now back to step 162, if conditions are not met, then at step 168, if pressure is below 90 and flow is not detected then the alarm is triggered at 126, if condition is not meet then at step 172, if pressure is below 30 psi and flow is over 50 Hz (frequency), then the alarm 170 is triggered at 126, if both previous conditions were not satisfied then back to step 148. Referring now back to step 144, if conditions are not met, then at step 150, if flow is below 10 Hz (frequency), for at least 5 seconds, possibly 10 seconds, then at step 178, if pressure is below 125 psi then alarm 152 is triggered at 126. If pressure is equal to or above 125, then back to step 148.

Referring back to step 150, if conditions were not satisfied, at step 154 pressure is below 30 psi and flow is above 50 Hz (frequency), then the alarm 156 is triggered at 126. At step 158, if AP (pressure) is equal or less 2 psi and Δflow=equal 0,then at 164, the system 90 has a clock function that measures accumulated run time up to 4 hours, before at step 166 BP is off. Back to steps 154 and 158 if conditions were not satisfied, the system 90 loops back to step 144.

If the external leak detector 108 is provided, at any step, if the detector senses a leak, then it is configured for triggering the alarm 126 at step 176. Also, at step 176, the PCB 92 in the control system 90 is also configured for monitoring hardware malfunctions including, but not limited to failure of the pressure sensor 82, malfunction of the flow meter 80 and failure of the pump 72. As such, the PCB 92 in the control system 90 is configured for generating an alarm signal in response to at least one of a water leak, a water inlet shutoff, pump malfunction, flow meter malfunction and pressure transducer malfunction.

While a particular embodiment of the present modular pump for a residential reverse osmosis system has been described herein, it will be appreciated by those skilled in the art that changes and modifications may be made thereto without departing from the invention in its broader aspects and as set forth in the following claims.

1. A modular pump for a water treatment system, comprising:
a housing having a water inlet and a separate water outlet;
a pump located in said housing and being in fluid communication with said water inlet;
a check valve located within said housing downstream of and in fluid communication with said pump;
a flow meter located within said housing and in fluid communication with, said check valve;
a pressure sensor located within said housing, in communication with, and downstream of said check valve and in fluid communication with the water outlet; and
a control system electrically connected to said pump, said pressure sensor and said flow meter.

2. The modular pump of claim 1, further including quick connect fittings connected to each of said water inlet and said water outlet.

3. The modular pump of claim 2, wherein said quick connect fittings are horizontally aligned with each other.

4. The modular pump of claim 1, further including two mounting brackets connected to said housing.

5. The modular pump of claim 1, wherein said housing fully surrounds said pump, said check valve, said flow meter, said pressure sensor and said control system.

6. The modular pump of claim 1, further including an external leak detector connected to said control system.

7. The modular pump of claim 1, wherein said control system is configured for generating an alarm signal in response to at least one of a water leak, a water inlet shutoff, an open faucet, pump malfunction, flow meter malfunction and pressure transducer malfunction.

8. The modular pump of claim 1, wherein said housing is provided on an external surface with flow direction indicators for facilitating connection to an existing water treatment system.

9. A water treatment system, including a prefilter, a multi-filter unit having an RO membrane unit, a treated water storage tank and a postfilter including the modular pump of claim 1.

10. The modular pump of claim 1, wherein said pump is constructed and arranged to activate based on at least one of a pressure signal and a flow signal based on water demand.

11. A modular pump for a water treatment system including an RO membrane and an RO treated water storage tank, said modular pump comprising:
a housing having a water inlet and a separate water outlet in fluid communication with the RO treated water storage tank;
a pump located in said housing and being in fluid communication with said water inlet;
a flow meter located within said housing and in fluid communication with said pump;
a pressure sensor located within said housing, in communication with said flow meter, and with the water outlet; and
a control system electrically connected to said pump, said flow meter and said pressure sensor and configured for operating said pump in response to signals generated by at least one of said flow meter and said pressure sensor, said signals reflecting water demand due to usage of treated water from the water storage tank.
